(19) United States
(12) Patent Application Publication
(10) Pub. No.: US 2002/0104690 A1
(43) Pub. Date: Aug. 8, 2002

(54) Load-sensing element for a scale

(75) Inventor: Michael Schurr, Murrhardt (DE)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Soehnle-Waagen GmbH, Murrhardt (DE)

(21) Appl. No.: 10/043,782

(22) Filed: Jan. 9, 2002

Related U.S. Application Data
(63) Continuation of application No. PCT/EP00/06011, filed on Jun. 28, 2000.

(30) Foreign Application Priority Data
Jul. 10, 1999 (DE) DE199 32 289.9-53

(51) Int. Cl. G01G 3/14; G01G 3/08

(52) U.S. Cl. 177/211; 177/229

(57) ABSTRACT

A load-sensing element is formed from a block of substantially rectangular cross section which is braced on a first end and which is adapted to receive a load to be measured on a second end. The block is pierced by an opening which is shaped such that at least two joints are created on each of a top side of the block and an underside of the block. The two joints on one of the top side and lower side of the block are offset from one another so as to compensate for a force eccentricity which occurs upon non-central introduction of the load to be measured. And a single strain gauge is disposed on the block in a vicinity of one of the offset joints.

This application is a continuation patent application of International Application PCT/EP00/06011 filed Jun. 28, 2000 which was not published under PCT Article 21(2) in English.

### FIELD OF THE INVENTION

The invention relates to a load-sensing element for a weighing scale, and to a circuit arrangement on the order of a Wheatstone Bridge, using load-sensing elements.

### DESCRIPTION OF RELATED ART

The prior art will be described below in conjunction with FIGS. 1-3.

FIGS. 1 and 2 show a tabletop scale, in which the load on a plate 2 is transmitted to a load-sensing element 1. A protrusion 3 from the plate 2 is coupled to the load-sensing element 1 on its left-hand end, and the load-sensing element 1 in turn is coupled to a fixed bottom plate 4 on its right-hand end. The dimensions of the load-sensing element 1 may, for example, be 150×25×40 mm. The dimensions of the area of the protrusion 3 may, for example, be 25×30 mm. The dimensions of the plate 2 may, for example, be 300×300 mm. And the load-sensing element 1 may, for example, be attached to the protrusion 3 and the fixed bottom plate 4 by two or four screws.

Disposed on the load-sensing element 1 are two strain gauges 5 and 6. In addition, the load-sensing element 1 is provided with an opening 7. The opening 7 takes the form of two ovals that merge with one another along one long side. In this way, by means of reduced cross sections of the material comprising the load-sensing element, bending points or joints 8, 9, 10, 11 are created, and the strain gauges 5, 6 are disposed above the joints 8, 9. Such a load-sensing element is disclosed, for example, in U.S. Pat. No. 4,655,305, WO 83/00222, EP 0 248 965 A1, EP 0 080 702 A2, EP 0 129 249 A2, and EP 0 227 850 A1.

The two strain gauges 5, 6 are connected as shown in FIG. 3 to two resistors 12, 13 to make a Wheatstone Bridge. The resistors 12, 13 can be fixed resistors or they can be additional strain gauges of a second load-sensing element.

Between the joints 8, 9 on the one hand and the joints 10, 11 on the other, there are formed “guide rods” 20, 21, respectively. The guide rods, considered in idealized terms, form a parallelogram, which shifts in response to a load, causing the guide rods themselves to bend in such a way that they assume an S shape as represented by dashed lines in FIG. 2.

Since the strain gauges 5, 6 are disposed in adjacent branches of a Wheatstone Bridge, their electrical effects are added together, as long as a voltage is applied to the terminals 22, 23, as shown. The derivation of a signal is then effected at terminals 24, 25.

If the load-sensing element 1 is loaded with a force F at the point I, in other words centrally, then a compressive or tensile stress occurs at each of the joints 8 and 9 in equal amounts. This is because of the bending of the guide rods into the S shape (see above). And upon being connected in a Wheatstone Bridge as shown in FIG. 3, the effects measured at the strain gauges 5, 6 are added together.

However, if the load-sensing element 1 is loaded with a force F eccentrically, for instance at the point II, then in addition to the bending moments caused in the case of loading at the point I, a bending moment M_{b}=F×l additionally occurs, which causes a tensile stress Z in the upper guide rod 20 and a compressive stress D in the lower guide rod 21. The additional tensile stress Z in the guide rod 20 causes an increase in resistance by the same amount in both strain gauges 5, 6. And since changes in resistance in the same direction compensate for one another in adjacent bridge branches of a Wheatstone Bridge, the output signal of the Wheatstone Bridge does not change as compared to the case of loading at the point I.

From this it can be seen that in this design with two strain gauges, at least given ideal geometric dimensions, the output signal is independent of the location of the force introduction point (I or II). The force introduction in this design can therefore be executed relatively imprecisely. On the other hand, this design does require two strain gauges.

German Patent DE 38 02 153 C2 discloses another prior art load-sensing element in which compensation for a shift in the point of force introduction can be achieved by means of an offset of two joints. The load-sensing element disclosed in this reference, however, also necessarily requires two strain gauges, and it is unusable with only a single strain gauge.

### OBJECT OF THE INVENTION

It is an object of the present invention to create a load-sensing element with which only a single strain gauge can be effectively used, so that production costs of the load-sensing element can be lowered considerably.

The object of the present invention, however, cannot be attained simply by omitting one strain gauge from the structure shown in FIG. 2. This is because the tensile stresses in the upper guide rod 20 which would occur in the case of loading at the point II described above (i.e., in the case of eccentric introduction of the force F) would no longer be compensated for, since the second strain gauge required for electrical compensation would be missing. And since the output signal of the load-sensing element is very highly dependent on the location of the force introduction, such a load-sensing element would be useless.

In practice, a change in the location of the force introduction is always due to asymmetrical contact points of the weights on the plate 2, or due to possible canting, and so forth.

### SUMMARY OF THE INVENTION

The object of the present invention is attained by forming a load-sensing element from a block which is pierced by an opening that is shaped such that at least two joints are created on each of a top side of the block and an underside of the block, wherein the two joints on one of the top side and lower side of the block are offset from one another so as to compensate for a force eccentricity which occurs upon non-central introduction of the load to be measured, and wherein a single strain gauge is disposed on the block in a vicinity of one of the offset joints.

### BRIEF DESCRIPTION OF THE DRAWINGS

FIG. 1 shows a plan view of a tabletop scale in accordance with the prior art;

FIG. 2 is a section taken along the line II-II of FIG. 1;

FIG. 3 shows a measurement circuit in the form of a Wheatstone Bridge for deriving a signal from a load-sensing element 1 of FIG. 2.

FIG. 4 shows a cross section through a load-sensing element 30 which represents one exemplary embodiment of the invention;

FIG. 5 shows a Wheatstone Bridge for deriving a measurement signal using the load-sensing element 30 of FIG. 4;

FIG. 6 shows a load-sensing element 100 according to another exemplary embodiment of the invention;

FIG. 7 shows a section taken along the line VII-VII of FIG. 6;

FIG. 8 shows a second structure incorporating the load-sensing element 100 into a scale;

FIG. 9 shows a structure incorporating four load-sensing elements into a scale according to yet another exemplary embodiment of the invention;

FIG. 10 shows the structure of a Wheatstone Bridge in the scale of FIG. 9 using known load-sensing elements 1 of FIG. 2;

FIG. 11 shows the structure of a Wheatstone Bridge with load-sensing elements 100 in the scale of FIG. 9, in accordance with the exemplary embodiment of the invention shown in FIGS. 6 and 7.

### DETAILED DESCRIPTION

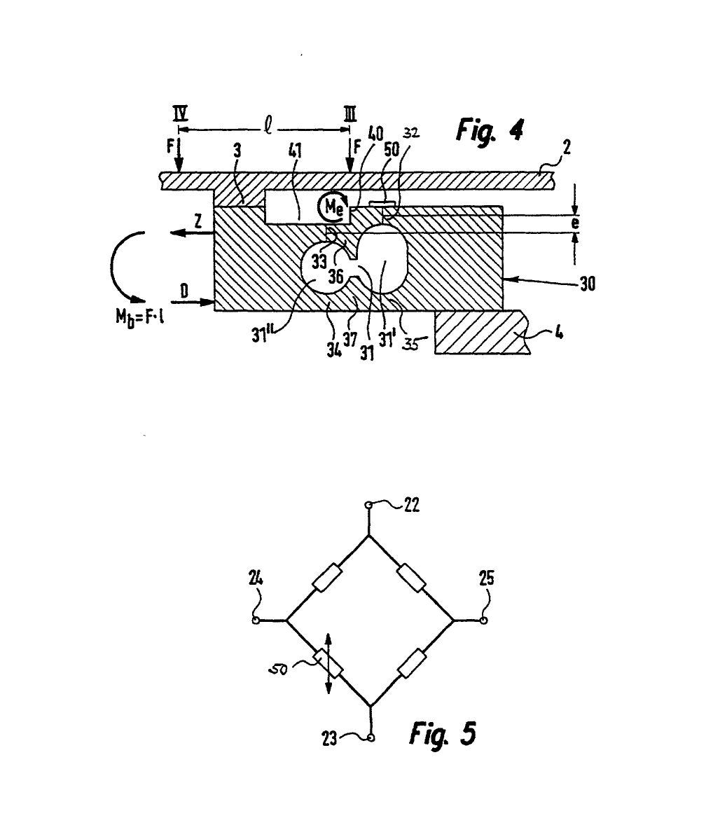

FIG. 4 shows a first exemplary embodiment of the invention in which an opening 31 is embodied in a load-sensing element 30 such that two joints or pivot points 32 and 33, between which an upper guide rod 36 is formed, are offset from one another in height by an amount e. Accordingly, the upper guide rod 36 and a lower guide rod 37, which is formed between two lower pivot points or joints 34, 35, do not form a parallelogram. Structurally, this is achieved by providing a shoulder 40, which is part of a recess 41 on the top side of the load-sensing element 30, in the middle between the joints 32 and 33 along the surface of the load-sensing element 30. The opening 31, moreover, is provided with two portions 31′ and 31″ having different heights, so that the properties of the joints as such, which depend on the thickness of the material at this point, are the same despite the offset e.

Above the right-hand portion 311 of the opening 31, there is provided only one strain gauge, namely the strain gauge 50.

The load-sensing element 30 of FIG. 4 reacts to loading at central and eccentric positions as follows.

If the load-sensing element 30 is loaded at point III with a force F, the load is accordingly exerted centrally, and thus the joint 32, which in a mechanical sense represents the actual measurement point, is loaded with a tensile stress. If the sensor is loaded outside the center, for instance at point IV, with a force F, then in addition to the bending moments in the case of loading at point III, an additional bending moment M_{b}=F×l also occurs, which causes a tensile stress Z in the upper guide rod 36 and a compressive stress D in the lower guide rod 37. As a result, the tensile stress in the region of the joint 32, which is accordingly picked up by the strain gauge 50, would tend to undesirably increase and lead to a stronger and hence adulterated output signal. However, because of the vertical offset by the amount e between the pivot points 32 and 33, a bending moment Mₑ=Z×e/2 occurs there, which counteracts the bending moment M_{b}. And by suitable dimensioning of the offset e, it is therefore possible to adjust the moment Mₑ in such a way that the torque M_{b} at the point below the strain gauge 50, that is, at the joint 32, is compensated for precisely. The error caused by eccentricity in the event of non-central force introduction is thus compensated for mechanically by means of a specially selected geometry in which the offset e is on the order of magnitude of from 1 to a few millimeters. In this way, a load-sensing element is created in which the output signal is independent of the force introduction point, even though only a single strain gauge is provided.

The above described load-sensing element 30, moreover, can also be used “upside down”. That is, the recess 41 and the strain gauge 50 can be disposed on the underside of the load-sensing element 30 in a symmetrically reversed mirror embodiment.

Since electrical compensation is no longer necessary, a Wheatstone Bridge can now be constructed with one load-sensing element 30 and three fixed resistors, as shown in FIG. 5 (with input at the terminals 22 and 23, and derivation of a signal at the terminals 24 and 25, as in FIG. 3). A load-sensing element in only one branch of the Wheatstone Bridge suffices, and this structure can therefore be referred to as a “quarter-bridge weighing cell”.

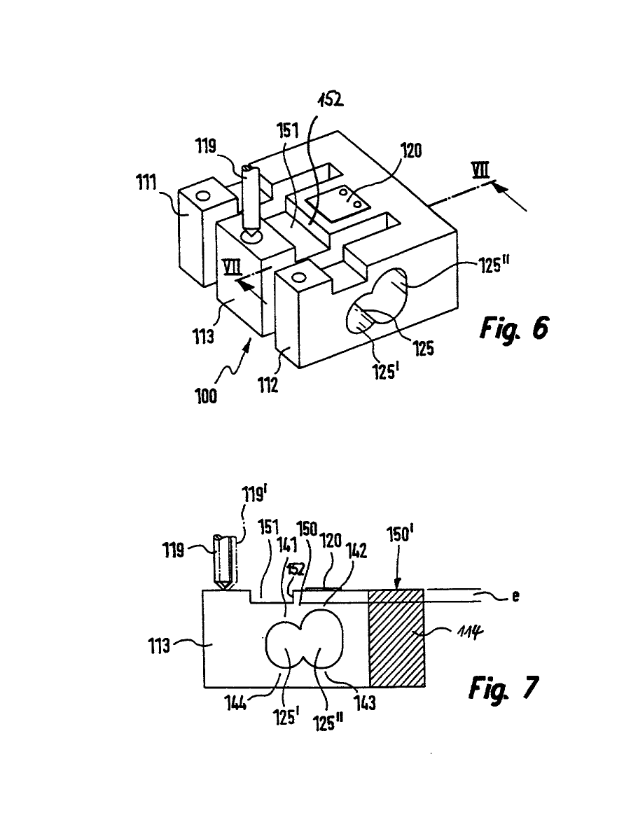

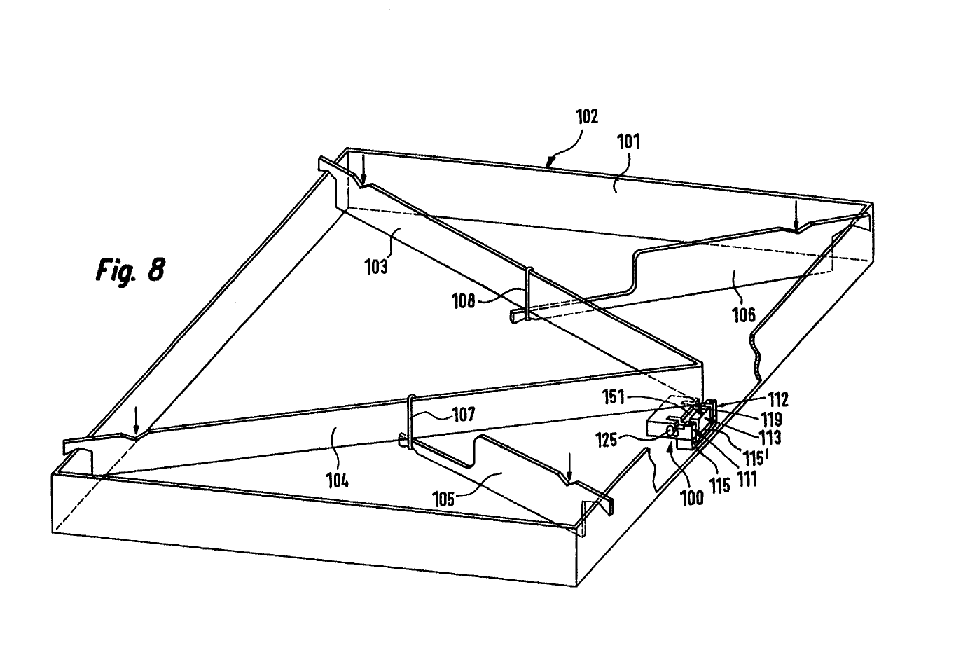

FIGS. 6 and 7 show another exemplary embodiment of the present invention in which a load-sensing element 100 is built into a scale of the design of FIG. 8. FIG. 8 shows the design of the scale schematically. At the edge 101 of a box 102, four levers 103, 104, 105, 106 are suspended. The levers 105 and 106 respectively engage the levers 103 and 104 approximately at the center thereof by means of a respective linkage elements 107 and 108. On their free end, the levers 103 and 104 are joined in a “V” and carry a pin 119, by way of which force introduction to the load-sensing element 100 is effected. The levers 105 and 106 are in turn loaded at the points marked with arrows by a plate (not shown) via a knife-like edge and block.

The load-sensing element 100 is formed by two outer members 111, 112 and one inner member 113, which are disposed parallel to one another and which are the same length and joined together by a cross-member 114. The form is E-shaped in plan view. The outer ends of the members 111, 112, as FIG. 8 shows, are secured to a bracket 115, which in the middle has an indentation 115′ so that the middle member 113 can be lowered.

The members 111, 112, 113 are each provided with an opening 125, and each opening comprises a substantially circular portion 125′ and a substantially oval portion 125″ which communicate with one another. As a result, due to the reduced cross sections of the material comprising the load-sensing element 100, joints or bending points 140, 141, 142 and 143 are created, in a manner similar to the joints 32-35 shown in FIG. 4. A strain gauge 120 is glued on or otherwise attached above the oval region 125″, over the joint 142.

A recess 151, which, as shown in FIG. 7 may be rectangular in cross section, is located in a region 150 on the top side of the beam 113—as on the other beams 111, 112—and is open toward the top, with a shoulder 152, in order to form an offset for achieving compensatory torque.

In a load-sensing element constructed in this way, the introduction of force takes place via the pin 119. As shown in FIG. 7, the dashed line indicates a position 119′ of the pin 119 that corresponds to a shift in the point of force introduction.

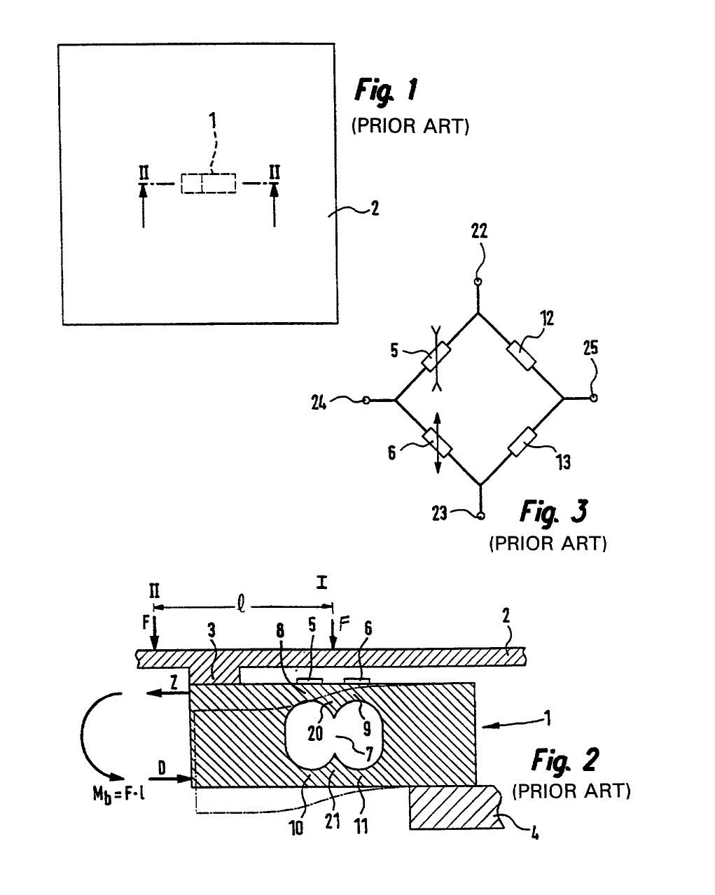

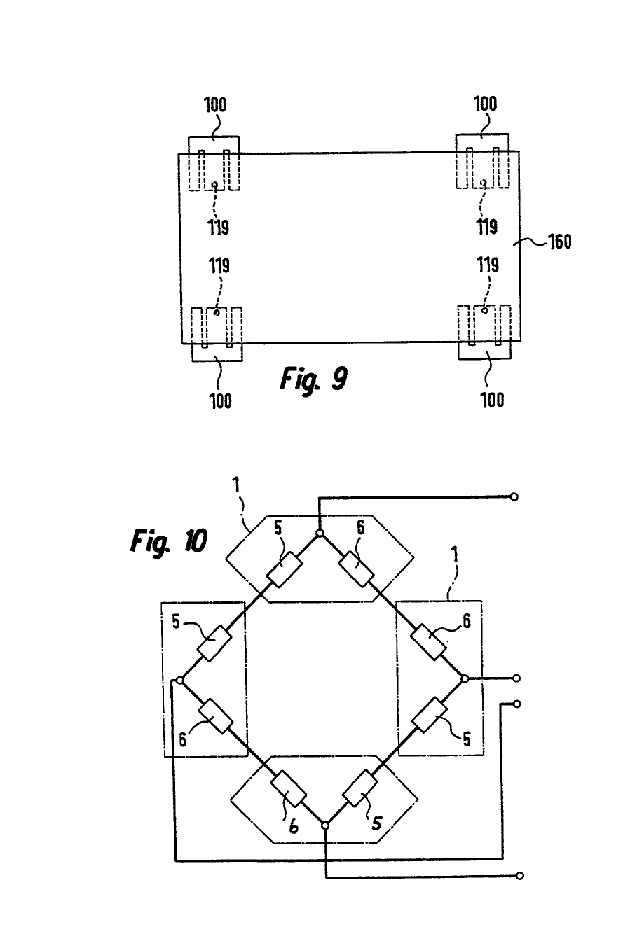

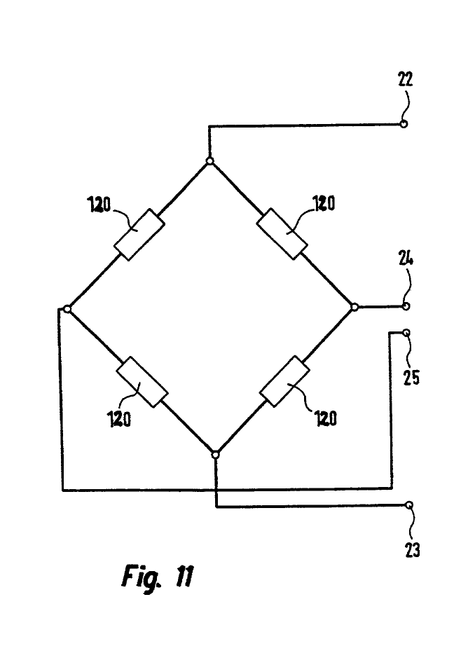

FIG. 9 shows the construction of a scale according to yet another exemplary embodiment of the invention which utilizes four load-sensing elements 100. A plate 160 and the weight acting on it are transmitted to the four load-sensing elements 100 via four pins 119. With this structure, if one wished to use the prior art load-sensing elements of the kind shown in FIGS. 1 and 2, it would be necessary to construct a Wheatstone Bridge as shown in FIG. 10 to compensate for non-central force introduction. In addition, it would be necessary to distribute two strain gauges 5, 6, on each load-sensing element, to adjacent branches of the Wheatstone Bridge in such a way that non-central force introduction would be compensated for electronically. A total of eight strain gauges would therefore be required.

Using load-sensing elements 100 of the exemplary embodiment of FIGS. 6 and 7, however, a Wheatstone Bridge in accordance with FIG. 11 can be constructed. In this structure, two diametrically opposed load-sensing elements are installed “upside down”. Accordingly, in comparison with the structure shown in FIG. 4 or FIG. 6, the load-sensing elements are rotated such that strain gauges 40 (or 120) and an offset point 40 (or 152) are located on the underside, so that for the same load, a measurement signal with the opposite sign occurs, and the signal changes in the load-sensing elements or their strain gauges disposed in adjacent branches of the Wheatstone Bridge are added together. As a result, it is sufficient to use four load-sensing elements 100, each with only one strain gauge 120. Thus, a fully electronic bridge can be constructed using four load-sensing elements 100. Such a Wheatstone Bridge, with a load-dependent load-sensing element in each branch, produces a much stronger signal than a Wheatstone Bridge of the kind shown in FIG. 5.

I claim:

1. A load-sensing element comprising:
a block of substantially rectangular cross section which is braced on a first end and which is adapted to receive a load to be measured on a second end; and
a single strain gauge disposed on the block;
wherein the block is pierced by an opening which is shaped such that at least two joints are created on each of a top side of the block and an underside of the block;
wherein the two joints on one of the top side and lower side of the block are offset from one another so as to compensate for a force eccentricity which occurs upon non-central introduction of the load to be measured; and
wherein the single strain gauge is disposed on the block in a vicinity of one of the offset joints.

2. The load-sensing element of claim 1, wherein a shoulder is formed on the top side of the block so as to offset the two joints on the top side of the block.

3. The load-sensing element of claim 2, wherein the two joints on the top side of the block each have a same material thickness.

4. The load-sensing element of claim 1, wherein the opening in the block comprises two different shaped portions.

5. The load-sensing element of claim 4, wherein the two different shaped portions of the opening have different heights.

6. The load-sensing element of claim 4, wherein the one of the two different shaped portions is substantially circular, and the other of the two different shaped portions is substantially oval.

7. The load-sensing element of claim 6, wherein the offset joints are respectively positioned above or below the substantially circular portion of the hole and the substantially oval portion of the hole.

8. The load-sensing element of claim 7, wherein the single strain gauge is disposed on the block in a vicinity of the one of the offset joints that is positioned above or below the substantially oval portion of the opening.

9. The load-sensing element of claim 1, wherein the offset is provided in a middle portion between the two joints on the top side of the block.

10. An electronic scale comprising:
four load-sensing elements each respectively arranged on one of four branches of a Wheatstone Bridge circuit arrangement;
wherein each of the four load-sensing elements comprises a block of substantially rectangular cross section which is pierced by an opening that is shaped to form offset adjacent pivot points for compensating for a force eccentricity which occurs upon non-central introduction of a load to be measured;
wherein only one strain gauge is disposed in each of the four branches of the Wheatstone Bridge circuit arrangement in association with one of the four load-sensing elements for measuring deformation at one of the offset adjacent pivot points of each of the four load-sensing elements; and
wherein respective diametrically opposed pairs of the four strain gauges are disposed to be deformed in opposite directions.

11. The electronic scale of claim 10, wherein the four strain gauges comprise a first diametrically opposed pair of strain gauges and a second diametrically opposed pair of strain gauges, and wherein the first diametrically opposed pair of strain gauges is arranged with an upward orientation and the second diametrically opposed pair of strain gauges is arranged with a downward orientation.

12. The electronic scale of claim 10, wherein signal changes in the load-sensing elements disposed in adjacent branches of the Wheatstone Bridge circuit arrangement are added together.
